(19) United States
(12) Patent Application Publication
(10) Pub. No.: US 2006/0120091 A1
(43) Pub. Date: Jun. 8, 2006

(54) LED table lamp

(76) Inventor: Se Kit Yuen, Hong Kong (HK)

Correspondence Address: Dr. Arthur King Ma, 1030 Coronado Drive, Arcadia, CA, 91007, US

(21) Appl. No.: 11/005,676

(22) Filed: Dec. 7, 2004

(51) Int. Cl. F21S 8/08

(52) U.S. Cl. 362/410

(57) ABSTRACT

This present invention relates to a LED table lamp utilizing light-emitting diode mean. The light-emitting diode table lamp uses the most simple and direct emitting diode as a transmitting source, which runs through a transparent plastic membrane to emit light in a safe and reliable manner and last for at least 100,000 hours. Said invention has an AC-DC converter that providing means of direct power from any outlets and charge the inserted plumbic acid chargeable battery. In the event of power cut in direct operation of the converter, the inserted battery could be used as simultaneous emergency power for the product. The intensity of light could be adjusted to alternative high or low intensity.

### BACKGROUND OF PRESENT INVENTION

1. Field of Invention

The present invention relates to a LED table lamp and more particularly, to a LED table lamp with a rechargeable lithium ion battery by utilizing a simple light-emitting diode (LED) as a source of illumination. When LED light passes through a circuit board, it generates speeding clear light.

2. Description of Related Arts

Conventional table lamp is often in a form of small, convenient and mobile “puck” lights. These puck lights are so called because they are often round and can be mounted and moved with a minimum of effort. These lights generally utilize fluorescent or incandescent lamps as a light source. Fluorescent and incandescent lamps typically require filaments and cathode tubes for operation. As such, they are fragile and have a relatively short operating life. Furthermore, filament lamps are not the most economical to operate. In addition, by producing light by heating a filament, incandescent lamps generate a great deal of heat. This heat builds up limits the effectiveness of traditional night light due to safety considerations and the possibility of unintentionally and adversely heating items on countertops. This heat generation also makes traditional puck lights less versatile in that some places in which such a light would be desired cannot accommodate a large buildup of heat (e.g. closets, shelves, etc.). Moreover, traditional incandescent and fluorescent lights are quite inefficient. An incandescent light converts a large amount of energy to heat rather than light and fluorescent lamps have a relatively high start up power consumption. Accordingly, new ways to provide more efficient lighting are desired.

As disclosed in U.S. Pat. No. 4,343,032, a night light generally consists of a base portion having prongs, which directly plug into a wall outlet. The base portion has a neck extension, which receives a small wattage bulb. A plastic shade or canopy fits over the bulb and such structure provide a nigh night with a very bulky outfit.

White-light LED systems provide significant benefits over traditional fluorescent and incandescent lamps. As white light producing LED systems become more refined and efficient, a need exists to expand the use of such systems into other areas, such as night light. Conventional fluorescent and incandescent lamps used in night light have multiple components (increasing the cost to manufacture), are fragile, and have a relatively short operating life.

U.S. Pat. No. 6,641,283 discloses an illumination system includes an LED module or housing and a mounting base. A plurality of LEDs is mounted on the module to serve as a light source and generates a light pattern. At least one optical assembly is operatively associated with the housing for focusing and dispersing the light pattern. The housing can be easily mounted and removed from the base unit to provide a flexible mounting architecture. However, again due to the base is required by this LED illumination system, cost of production is higher and a bulky outfit of this LED illumination is a must. U.S. Pat. No. 6,648,496 provides a night light assembly includes a wall plate adapted to fit over a switch plate extending from a substantially planar surface. The wall plate engages and abuts the substantially planar surface upon mounting the nightlight in its final operating position. At least one light emitting diode (LED) is mounted within the wall plate, which serves as the light source for the nightlight. This patent suggests a manner to provide a slimmer night light however, due to the nature of conventional LEDs, a relatively short-time-life of such LED illumination is remain an unsolved problems.

### SUMMARY OF SAID PRESENT INVENTION

A main object of the present invention is provide a LED table lamp by utilizing a simple light-emitting diode (LED) as a source of illumination to provide a reliable lighting mean

Another object of the present invention is provide a LED table lamp by utilizing a simple light-emitting diode (LED) as a source of illumination and a simple light-emitting diode (LED) as a source of illumination. When LED light passes through a circuit board, it generates speeding clear light.

Another object of the present invention is provide a LED table lamp by eliminating all unnecessary components to a table lamp.

Accordingly, in order to accomplish the above objects, the present invention provides a LED table lamp, which comprises:

a housing consists of a front panel and a back panel,

a protective cover including an optical assembly for focusing and dispersing LED emitted light to a desired light contour enclosing at least a portion of the housing; and

at least one light-emitting diode (LED) as a illuminant, and

a plurality of circuit boards with a plurality of polyester cover capacitors, a plurality of resistances, a plurality of metal power plug, and

### BRIEF DESCRIPTION OF SAID DRAWINGS

FIG. 1 is a front view of the present invention.

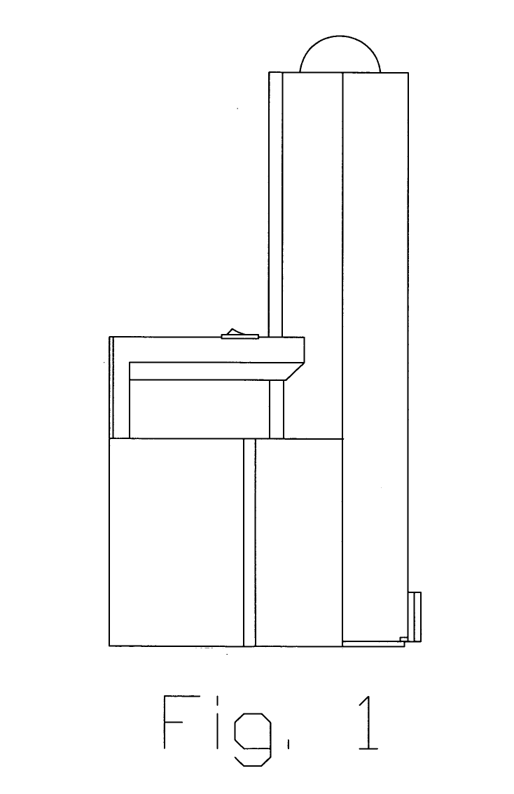

FIG. 2 is a front sectional view thereof;

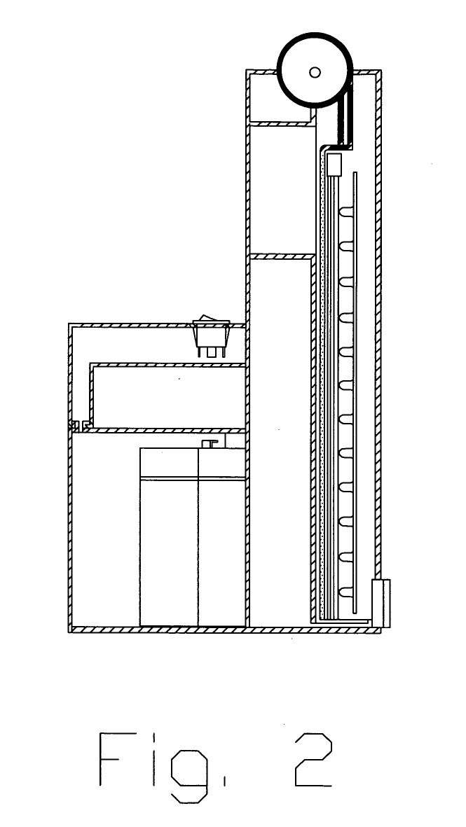

FIG. 3 is a plan sectional view thereof;

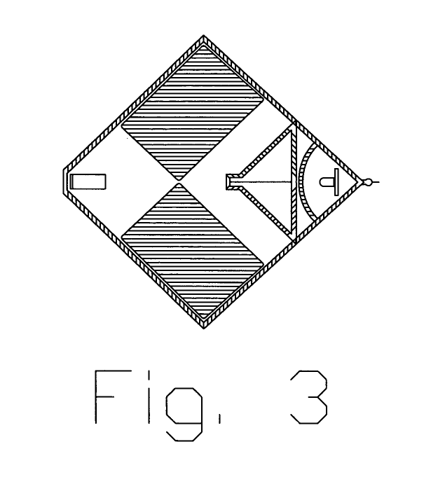

FIG. 4 is a plan view thereof;

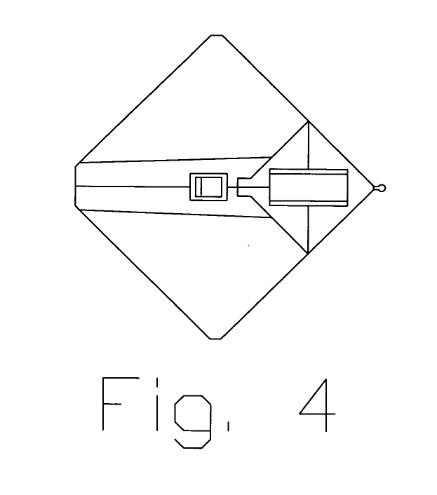

FIG. 5 is an underneath view thereof;

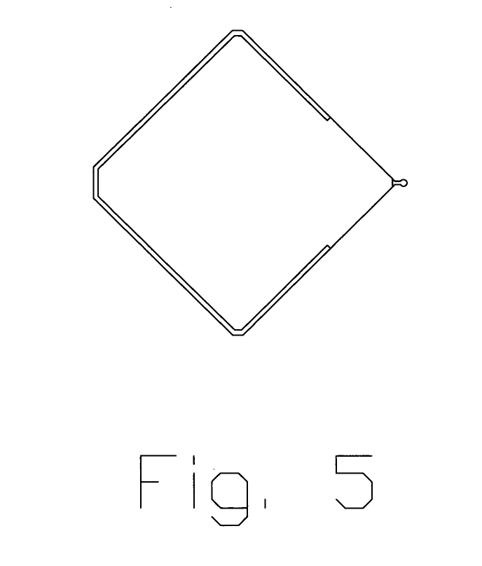

FIG. 6 is a rear view thereof;

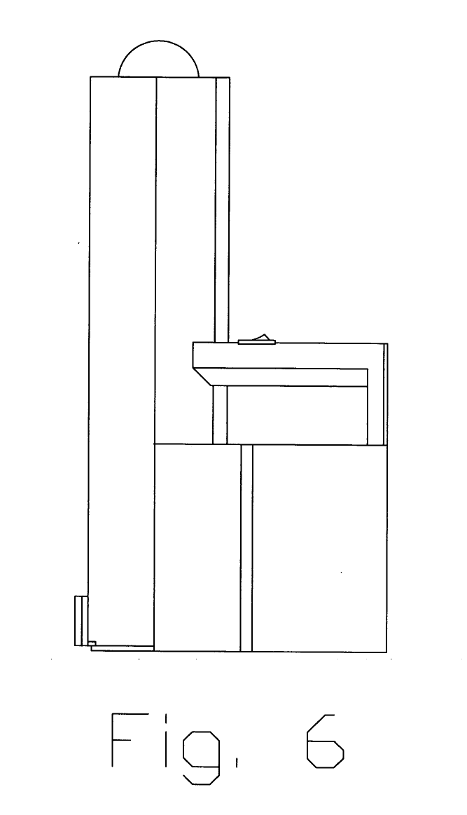

FIG. 7 is a side view thereof;

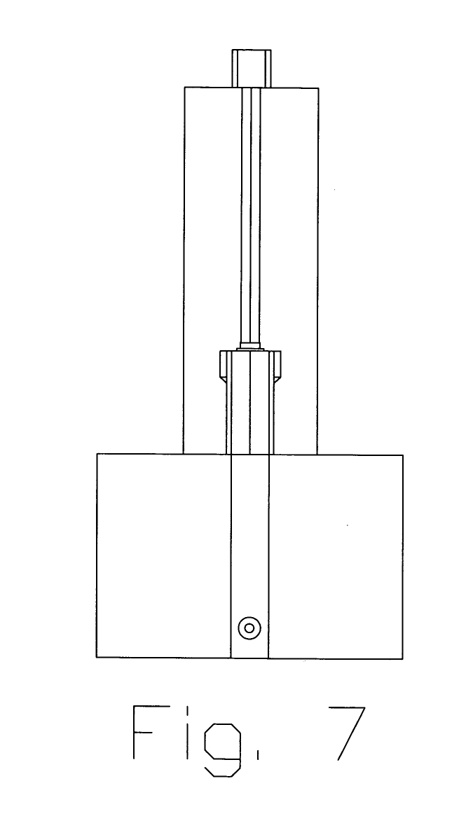

FIG. 8 is another side view thereof;

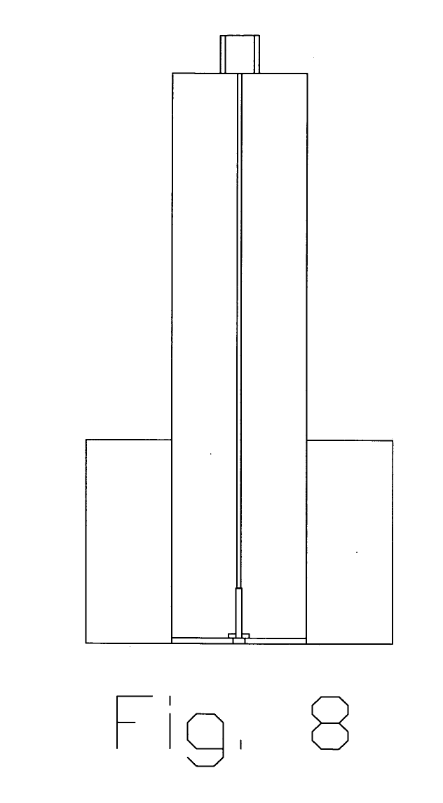

FIG. 9 is an isometric view of the present invention.

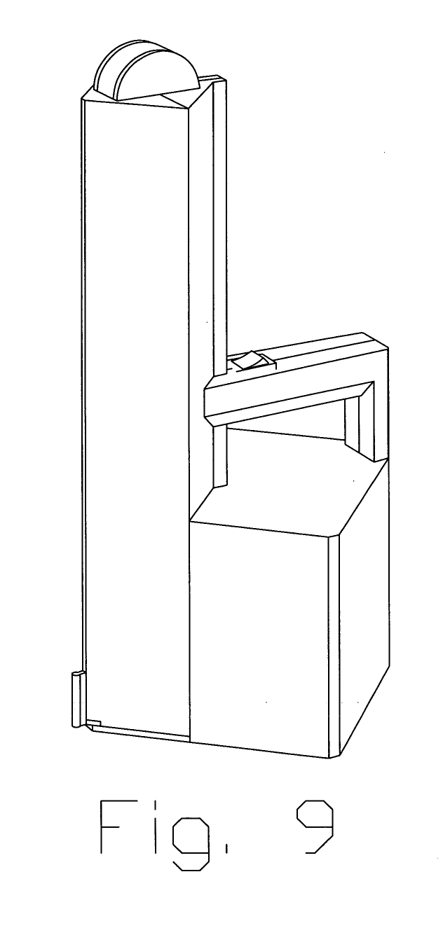

FIG. 10 is a composite view thereof.

### DETAILED DESCRIPTION OF SAID PREFERRED EMBODIMENT

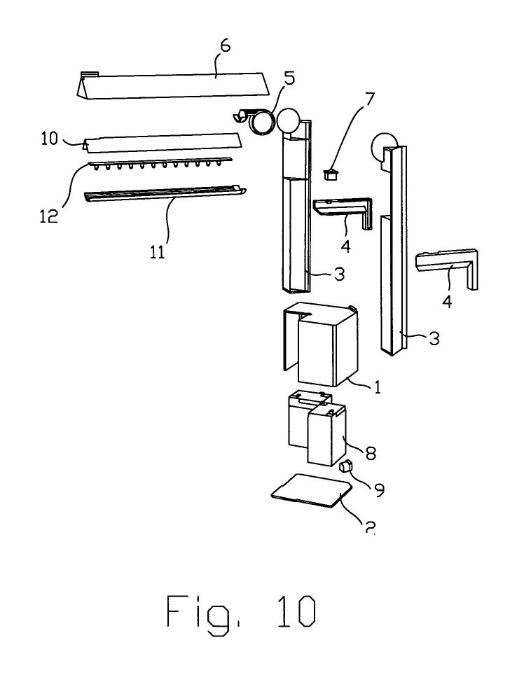

Referring to FIG. 10, this LED table lamp has a housing consists of a front panel (1) and a back panel (2). Said panel has no predetermined shape. It can be rectangular, round and any other shape depending on any specification ordered. Inside of said front and back panels, upright left/right arm (3), a handle bar (4), a revolving shaft (5), a rotation arm (6) and a switch (7), plumbic acid charging battery (8), DC electric socket (9), reflector plate (10), transparent plastic membrane (11) and a circuit board installed with twelve emitting diode (12). Said switch (7) is affixed on said upright left/right arm (3). It passes through two holes on a lower portion of said back panel (2) while said upright left/right arm (3) is affixed in between said front panel (1) and back panel (2).

The plumbic acid charging battery and the DC electric socket are installed within the master shield, and the switch on the handle bar. The upright arms and rotation arms are connected by revolving shaft. The reflector plate, transparent plastic membrane and the circuit board installed with twelve emitting diode are installed onto the rotation arms.

As the AC-DC converter is plugged into the AC power socket, the output end of the converter is connected to the DC electric socket on the master shield. Push the switch down to directly drive the diode to emit light. The penetrating source runs through the transparent plastic membrane to give out light. Otherwise the converter charges the inserted plumbic acid charging battery through the electric circuit in the master shield at output end. After charging, the battery can be used as direct power. In the event of power failure during direct operation by converter, the inserted battery can provide power to the product as an emergency source. The intensity of light can be adjusted to alternative high or low intensity by switching operation. The charging battery can provide continuous operation up to 32 hours at low light-intensity or 16 hours at high light-intensity.

Said LED wall plate night light provides an ability to adopt power source directly on any wall outlet of AC (alternate current), which is provided by any public utility provider. As electricity passes through said circuit board (9) inside of said front panel (1) and back panel (2), lower down 120 voltages from AC to activate the light-emitting diode to illuminate.

After LED light passes through a circuit board, it generates speeding clear lights which can remain stable over an extended period of time and will not affected by any weather condition. The circuit board allows light to form an evenly distributed glow. The electric circuit module includes a circuit board, a metal like polyester covering capacitor, two resistances, one diode and two light-emitting diodes.

It is the lifespan of said LED (12) to offer at least 100,000 light hours, therefore, said LED table lamp provides a relative longer usage than conventional night lights.

What is claimed is:

1. A LED table lamp comprises:
a housing consists of a front panel and a back panel,
a protective cover including an optical assembly for focusing and dispersing LED emitted light to a desired light contour enclosing at least a portion of the housing; and
at least one light-emitting diode (LED) as a illuminant, and
a plurality of circuit boards with a plurality of polyester cover capacitors, a plurality of resistances,
a plurality of metal power plug is affixed on said circuit board and it passes through two hold on a lower portion of said back panel while said circuit board of affixed in between said front panel and back panel.

2. A LED table lamp as recited in claim 1, wherein, said circuit board further comprises:
a plurality of metal polyester covering capacitors,
a plurality of resistances,
at least one diode and a plurality of light-emitting diodes.

3. A circuit board as recited in claim 1, wherein said LED table lamp provides an ability to adopt power source directly on any wall outlet of AC (alternate current), which is provided by any public utility provider.

4. A LED table lamp as recited in claim 1, wherein said front panel and back panel has no predetermined size and shape.

5. A LED table lamp as recited in claim 1, wherein surface of said front panel has a display window with a predetermined size and shape, which contains a circuit board conforming with said predetermined size and shape of said hole.

6. A LED table lamp as recite in claim 1, wherein, as electrical current passes through said metal power plug into a circuitry that lowers down 120 voltages to a level that activates said light-emitting diodes and light is thereby transmitted. Said light passes through said circuit board, generates speed light, and said circuit board allows light to form an evenly distributed glow, making it a safe and reliable way of illumination.

7. A LED table lamp comprises:
a housing consists of a front panel and a back panel,
a protective cover including an optical assembly for focusing and dispersing LED emitted light to a desired light contour enclosing at least a portion of the housing; and
at least one light-emitting diode (LED) as a illuminant, and
a plurality of circuit boards with a plurality of polyester cover capacitors, a plurality of resistances,
a plurality of metal power plug is affixed on said circuit board and it passes through two hold on a lower portion of said back panel while said circuit board of affixed in between said front panel and back panel, and
Wherein said circuit board further comprises:
a plurality of metal polyester covering capacitors,
a plurality of resistances,
at least one diode and a plurality of light-emitting diodes.

8. A circuit board for LED table lamp comprises:
a plurality of metal power plug, and
a plurality of metal polyester covering capacitors, and
a plurality of resistances, and
at least one diode and a plurality of light-emitting diodes wherein, as electrical current passes through said metal power plug into a circuitry that lowers down 120 voltages to a level that activates said light-emitting diodes and light is thereby transmitted.

9. A circuit board for LED table lamp as recited in claim 8, wherein said LED table lamp provides an ability to adopt power source directly on any wall outlet of AC (alternate current), which is provided by any public utility provider.

10. A circuit board for LED table lamp as recited in claim 8, wherein said LED table lamp provides an ability to adopt power source directly on any wall outlet of AC (alternate current), which is provided by any public utility provider.
